(19) United States
(12) Patent Application Publication
(10) Pub. No.: US 2026/0032090 A1
(43) Pub. Date: Jan. 29, 2026

(54) TRANSMITTING A DATA PACKET

(71) Applicant: Landis+Gyr Technology, Inc., Alpharetta, GA (US)

(72) Inventors: Shobhit Kumar SINGH, Noida (IN); Saurabh JAIN, Noida (IN); Sandeep KUMAR, Noida (IN); Anil Kumar TYAGI, Noida (IN); Mudit GOYAL, Noida (IN)

(21) Appl. No.: 19/273,561

(22) Filed: Jul. 18, 2025

Related U.S. Application Data
(60) Provisional application No. 63/674,432, filed on Jul. 23, 2024.
(60) Provisional application No. 63/674,454, filed on Jul. 23, 2024.
(60) Provisional application No. 63/674,427, filed on Jul. 23, 2024.
(60) Provisional application No. 63/674,447, filed on Jul. 23, 2024.

(51) Int. Cl. H04L 47/24; H04L 67/12

(52) U.S. Cl. CPC H04L 47/24; H04L 67/12

(57) ABSTRACT

A method for transmitting a data packet (e.g. between nodes in a mesh network). If a received transmission is consistent, the data packet is transmitted within a first interval if a counter is less than a redundancy constant, or if the counter is greater than or equal to the redundancy constant, and if a suppression interval count is greater than or equal to a suppression interval value. If the received transmission is inconsistent, the data packet is transmitted within a second interval. A node in a mesh network is also described.

### TECHNICAL FIELD

The present application relates to a method for transmitting a data packet, in particular between nodes in a mesh network, and to a node in a mesh network.

### BACKGROUND

The Trickle algorithm is defined in RFC 6206 (available at https://www.rfc-editor.org/rfc/rfc6206, the contents of which is hereby incorporated by reference), and is used to control the transmission of information in a network.

The Trickle algorithm employs a simple suppression mechanism such that nodes within the network do not all transmit the same information at the same time, leading to redundancy, while also ensuring that messages reach all nodes in the network within an acceptable timeframe.

However, the Trickle algorithm is a static algorithm and may not, for example, be adaptive to run time network environmental conditions.

### SUMMARY

The present disclosure provides various improvements to the Trickle algorithm that may result in a more adaptive algorithm.

Described herein is a method for transmitting a data packet (e.g. between nodes in a mesh network), the method comprising: setting a first interval duration for a first interval, wherein the first interval duration is between a minimum interval duration and a maximum interval duration. The method comprises receiving (e.g. by a node within the mesh network) a first transmission.

If the first (received) transmission is consistent (e.g. with a state of the node), the method comprises incrementing a counter. If the counter is less than a redundancy constant, the method comprises transmitting data packet at a time within the first interval. If the counter is greater than or equal to the redundancy constant, and if a suppression interval count is greater than or equal to a suppression interval value, transmitting the data packet at the time within the first interval. At the end of the first interval, if no data packet was transmitted within the first interval, the method comprises incrementing the suppression interval count. If, at the end of the first interval, the first interval duration is less than the maximum interval duration, the method comprises setting a subsequent interval duration for a subsequent interval, the subsequent interval duration being greater than the first interval duration.

If the first (received) transmission is inconsistent (e.g. with the state of the node), the method comprises: setting a second interval duration for a second interval to the minimum interval duration; setting the counter to zero; transmitting the data packet at a time within the second interval; and at the end of the second interval, setting the subsequent interval duration for the subsequent interval, the subsequent interval duration being greater than the second interval duration.

Also described herein is a node in a mesh network, the node comprising: a processor; and a memory configured to store computer-readable instructions that, when executed by the processor, cause the processor to perform operations comprising: setting a first interval duration for a first interval, wherein the first interval duration is between a minimum interval duration and a maximum interval duration.

The operations comprise, upon receipt by the node of a first transmission, if the first (received) transmission is consistent (e.g. with a state of the node): incrementing a counter; if the counter is less than a redundancy constant, causing the node to transmit, at a time within the first interval, a data packet to a second node of the mesh network; if the counter is greater than or equal to the redundancy constant, and if a suppression interval count is greater than or equal to a suppression interval value, transmitting the data packet at the time within the first interval; and at the end of the first interval: if no data packet was transmitted within the first interval, incrementing the suppression interval count; if the first interval duration is less than the maximum interval duration: setting a subsequent interval duration for a subsequent interval, the subsequent interval duration being greater than the first interval duration.

The operations comprise, upon receipt by the node of the first transmission, if the first (received) transmission is inconsistent (e.g. with the state of the node): setting a second interval duration for a second interval to the minimum interval duration; setting the counter to zero; transmitting the data packet at a time within the second interval; and at the end of the second interval, setting the subsequent interval duration for the subsequent interval, the subsequent interval duration being greater than the second interval duration.

The present disclosure therefore provides a variation on the Trickle algorithm in which transmission of the data packet is not suppressed in certain cases when the counter reaches or exceeds the redundancy constant value. Specifically, when the suppression interval count is greater than or equal to the suppression interval value. It will be understood that the suppression interval value refers to the number of intervals over which transmission of the data packet should be suppressed.

The present disclosure therefore provides a way to ensure that certain data packets are transmitted, without requiring a reset of the Trickle timer, which may be useful for transmission of certain critical information that changes frequently such as the network size.

In some examples, when the first (received) transmission is consistent (e.g. with the state of the node), if an ignore interval count is greater than or equal to an ignore interval value, the suppression interval count is set to zero.

It will be understood that the ignore interval value refers to a number of intervals over which data packets may be transmitted irrespective of the value of the counter.

As described herein, a time within an interval may be a random time within said interval.

### BRIEF DESCRIPTION OF THE DRAWINGS

The invention will now be described, by way of example only, with reference to the following drawings:

FIG. 1 illustrates a flow diagram of the Trickle algorithm according to RFC 6206;

FIG. 2 illustrates an example of a method for transmitting a data packet according to the present disclosure, in which multiple transmissions take place within an interval;

FIG. 3 illustrates an example of a method for transmitting a data packet according to the present disclosure, in which the interval duration is kept the same for at least some intervals;

FIG. 4 illustrates an example of a method for transmitting a data packet according to the present disclosure, in which the interval duration is reset for only one or more intervals;

FIG. 5 illustrates an example of a method for transmitting a data packet according to the present disclosure, in which transmission suppression may be prevented for one or more intervals;

FIG. 6 schematically illustrates an example of a node according to the present disclosure; and

FIG. 7 is a block diagram illustrating an example of a networked system and a mesh network.

### DETAILED DESCRIPTION

The Trickle algorithm, defined in RFC 6206 (available at https://www.rfc-editor.org/rfc/rfc6206, the contents of which is hereby incorporated by reference), enables the exchange of information in a network in an energy efficient manner.

According to the RFC (Request for Comments), a Trickle timer runs for a defined interval, I, and in each interval, timer ‘t’ is calculated between I/2 and I. On expiry of t, transmission of a data packet occurs. On expiry of I, the next interval starts whose duration is double that of the previous interval.

The following configurable parameters are defined for the Trickle algorithm in RFC 6206:
Imin: Minimum Interval Size (defined in units of time, e.g. milliseconds, seconds, etc.). The Trickle interval, I, is initialized with the Imin value.
Imax: Maximum Interval Size. This is the maximum duration that can be reached by the Trickle interval, I. According to RFC 6206, Imax may be described as a number of doublings of the minimum interval size (the base-2 log(max/min)).
Icrt: Random value between Imin & Imax. Initially Icrt is Imin and can be as high as Imax.
t: Time during interval, I, when an event (e.g. transmission of a data packet) will be triggered.
k: Redundancy constant.
c: Counter, which is incremented whenever any consistent information is received (e.g. by a node in a network). At timer t, the value of c should be less than K.

According to RFC 6206, the Trickle algorithm has the following rules:
1. When the algorithm starts execution, it sets I to a value in the range of [Imin, Imax]—that is, greater than or equal to Imin and less than or equal to Imax. The algorithm then begins the first interval.
2. When an interval begins, Trickle resets c to 0 and sets t to a random point in the interval, taken from the range [I/2, I], that is, values greater than or equal to I/2 and less than I. The interval ends at I.
3. Whenever Trickle hears a transmission that is “consistent”, it increments the counter c.
4. At time t, Trickle transmits if and only if the counter c is less than the redundancy constant k.
5. When the interval I expires, Trickle doubles the interval length. If this new interval length would be longer than the time specified by Imax, Trickle sets the interval length I to be the time specified by Imax.
6. If Trickle hears a transmission that is “inconsistent” and I is greater than Imin, it resets the Trickle timer. To reset the timer, Trickle sets I to Imin and starts a new interval as in step 2. If I is equal to Imin when Trickle hears an “inconsistent” transmission, Trickle does nothing. Trickle can also reset its timer in response to external “events”.

The terms “consistent”, “inconsistent”, and “events” depend on the particular protocol employing the algorithm.

As used herein, a consistent transmission refers to a message (i.e. a transmission) which is already been received by device and has no new information, and is therefore consistent with a state of the node.

As used herein, a non-consistent, or inconsistent, transmission refers to message (i.e. a transmission) which has new information and has not been received previously, and is therefore not consistent with the state of the node.

Examples of transmissions and data packets described herein may include software/firmware version numbers and updates, and information relating to the number of nodes in a network and/or their locations, statuses, security parameters, or other properties.

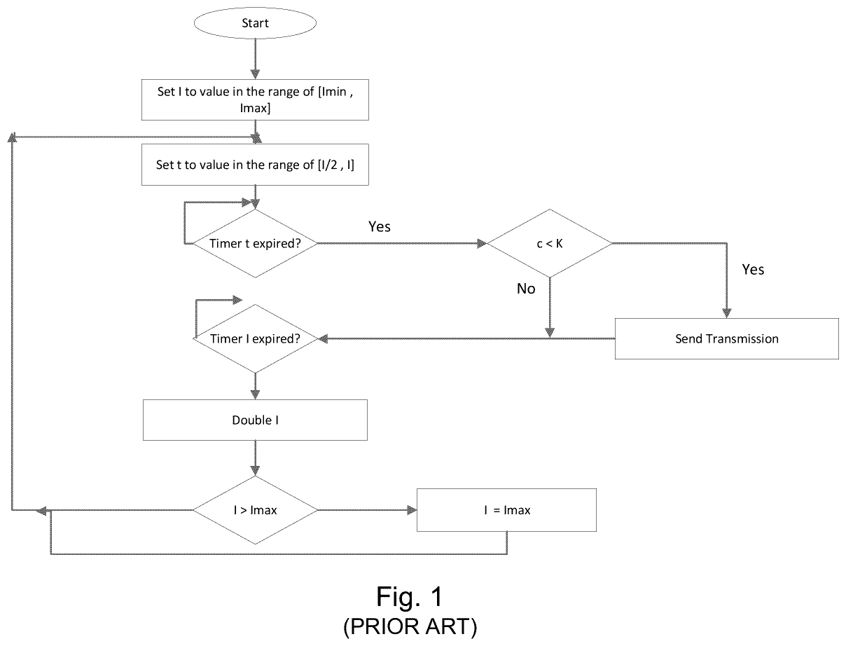

FIG. 1 illustrates a flow diagram of the Trickle algorithm according to RFC 6206.

The Trickle algorithm defined in RFC 6206 is a static algorithm, and may not be adaptive to run time network environmental conditions. For example, the redundancy constant may not be adaptive based on changing network conditions, and the interval length cannot be changed upon detection of a change in environment. In addition, upon a reset of the Trickle timer, it takes a complete algorithm to reach the maximum interval length, whereas in some cases it may not be preferred to increase the interval length gradually. Furthermore, the Trickle algorithm defined in RFC 6206 may lead to scenarios in which node messages are suppressed in every interval, meaning that other nodes (e.g. a child node) may not be able to receive messages.

The present disclosure therefore provides various improvements to the Trickle algorithm that may address one or more of the above deficiencies.

Non-limiting examples according to the present disclosure will now be described.

### Multiple Transmissions in an Interval

As described herein, according to the Trickle algorithm defined in RFC 6206, a node in a network transmits a data packet at a time, t, calculated randomly in the range [I/2, I] in the interval, I. Importantly, according to the Trickle algorithm defined in RFC 6206, a node can transmit only once in an interval. The next transmission of the data packet will occur in the next interval.

However, there can be scenarios in which a critical message needs to be broadcasted quickly (i.e. without waiting for the next interval). Therefore, in some examples according to the present disclosure, a node may perform multiple transmissions in a single Trickle interval. Performing multiple transmissions in an interval may be particularly useful in the case of a sparse or noisy network where the overall number of transmissions between nodes is low.

According to some examples according to the present disclosure, there may exist multiple timers or times (e.g. t1, t2, t3, etc.) within an interval (e.g. within the range [I/2, I]). A node may transmit at these times if the counter, c, is less than the redundancy constant, k. In some examples, this approach may be applied according to a Quality of Service (QoS) defined for the message or data packet. For example, a high priority message may use the multiple timer implementation described herein, while a lower priority message may employ the Trickle algorithm defined in RFC 6206. In some examples, a configuration may be applied to a node (e.g. at run time, or at manufacture), in which the number of timers in an interval may be defined.

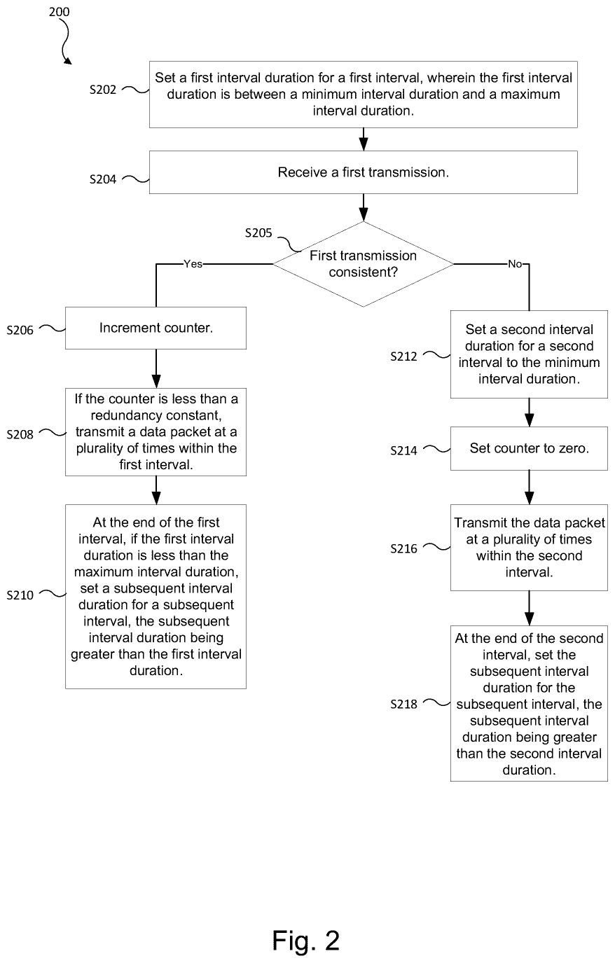

An example of a method 200 for transmitting a data packet (e.g. between nodes in a network such as a mesh network) according to the present disclosure, in which multiple transmissions take place within an interval, is illustrated schematically in FIG. 2.

In a step S202 of the method 200, a first interval duration for a first interval (e.g. I) is set, wherein the first interval duration is between a minimum interval duration (e.g. Imin) and a maximum interval duration (e.g. Imax).

In a step S204, the method 200 comprises receiving a first transmission (e.g. from another node in the network).

If (at S205) the first transmission is consistent, the method 200 comprises, in a step S206, incrementing a counter (e.g. counter c).

If the counter is less than a redundancy constant (e.g. redundancy constant k), the method 200 comprises, in a step S208, transmitting a data packet at a plurality of times (e.g. times t1, t2, t3, etc.) within the first interval. For example, the plurality of times within the first interval may occur after half of the first interval duration (i.e. in the range [I/2, I]).

For example, the data packet may be transmitted twice or more times within the first interval.

If, at the end of the first interval, the first interval duration is less than the maximum interval duration, the method 200 comprises, in a step S210, setting a subsequent interval duration for a subsequent interval, the subsequent interval duration being greater than the first interval duration. For example, the subsequent interval duration may be double the first interval duration.

If (at S205) the first transmission is inconsistent, the method 200 comprises, in a step S212, setting a second interval duration for a second interval to the minimum interval duration and, in a step S214, setting the counter to zero.

In a step S216, the method 200 comprises transmitting the data packet at a plurality of times (e.g. times t1, t2, t3, etc.) within the second interval. For example, the plurality of times within the second interval may occur after half of the second interval duration (i.e. in the range [I/2, I]). For example, the data packet may be transmitted twice or more times within the second interval.

At the end of the second interval, the method 200 comprises, in a step S218, setting the subsequent interval duration for the subsequent interval, the subsequent interval duration being greater than the second interval duration. For example, the subsequent interval duration may be double the second interval duration.

### Same Interval Length for Consecutive Intervals

According to the Trickle algorithm defined in RFC 6206, at the start of the algorithm, the interval duration, I, is set to the minimum interval duration, Imin. When the interval expires, the interval duration is doubled until the maximum interval duration, Imax, is reached.

However, there may exist scenarios in which a critical message such as security information, configuration messages, and/or outage messages need to be broadcasted quickly, and doubling each interval may not be favorable for performance in such cases.

Therefore, in some examples according to the present disclosure, in at least some cases at the end of the interval the interval duration may not increase. For example, the interval duration may remain as the minimum interval duration for a defined number of intervals (e.g. defined in an algorithm as SAME_TRICKLE_INTERVAL_COUNT).

This approach may be particularly useful for the transmission of certain specific application layer messages such as outage messages or critical configuration messages from a network controller or collector. In other examples, if a node has detected some critical change (e.g. in configuration) but has not received the relevant information, then the node can solicit that information employing the algorithm described herein in which the interval duration is kept the same.

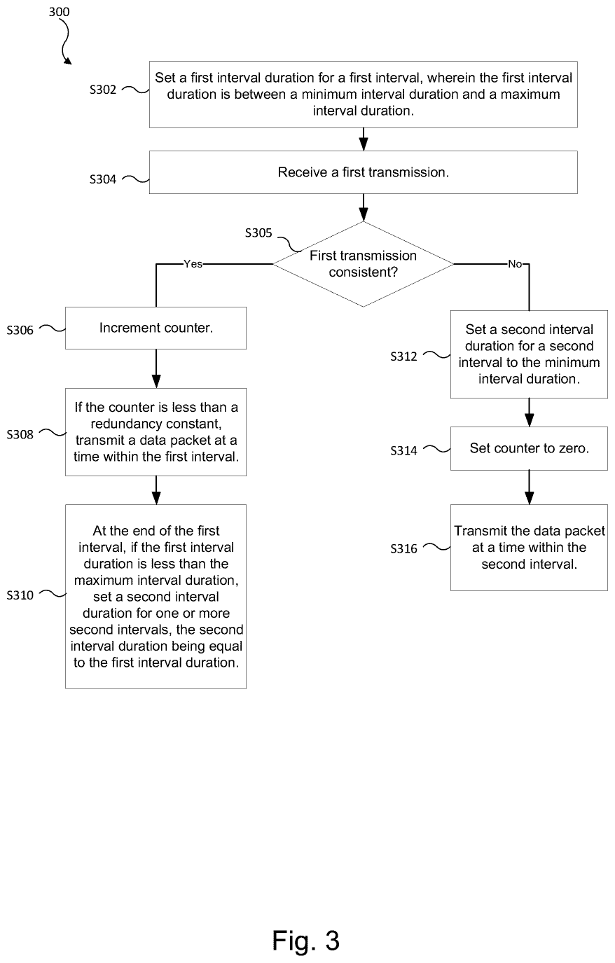

An example of a method 300 for transmitting a data packet (e.g. between nodes in a network such as a mesh network) according to the present disclosure, in which the interval duration is kept the same for at least some intervals, is illustrated schematically in FIG. 3.

In a step S302 of the method 300, a first interval duration for a first interval (e.g. I) is set, wherein the first interval duration is between a minimum interval duration (e.g. Imin) and a maximum interval duration (e.g. Imax).

In a step S304, the method 300 comprises receiving a first transmission (e.g. from another node in the network).

If (at S305) the first transmission is consistent, the method 300 comprises, in a step S306, incrementing a counter (e.g. counter c). If the counter is less than a redundancy constant (e.g. redundancy constant k), the method 300 comprises, in a step S308, transmitting a data packet at a time (e.g. time t) within the first interval. For example, the time within the first interval may occur after half of the first interval duration (i.e. in the range [I/2, I]). If, at the end of the first interval, the first interval duration is less than the maximum interval duration, the method 300 comprises, in a step S310, setting a second interval duration for a second interval, the second interval duration being equal to the first interval duration. For example, the first interval duration (and therefore the second interval duration being equal to the first interval duration) may be equal to the minimum interval duration.

If (at S305) the first transmission is inconsistent, the method 300 comprises, in a step S312, setting a second interval duration for a second interval to the minimum interval duration and, in a step S314, setting the counter to zero. In a step S316, the method 300 comprises transmitting the data packet at a time (e.g. time t) within the second interval. For example, the time within the second interval may occur after half of the second interval duration (i.e. in the range [I/2, I]).

In some examples, at the end of the second interval, the method 300 may comprise setting a subsequent interval duration for one or more subsequent intervals (not shown). For example, after the defined number of intervals (e.g. SAME_TRICKLE_INTERVAL_COUNT described above) has passed. The subsequent interval duration may be greater than the first interval duration. For example, the subsequent interval duration may be double the first interval duration.

In some examples, at least some data packets may be transmitted at a plurality of times within the first interval, the second interval, and/or a subsequent interval, as described herein.

### Determining Trickle Parameters Based on an Environment Condition

The Trickle algorithm defined in RFC 6206 can be used under various conditions and with various configurations. For example, the algorithm can be used to transmit messages such as DIS and DIO for discovery of RPL networks. The algorithm can also be used to transmit network discovery solicit messages such as EBR in the IEEE 802.15.4 standard, and to respond with network discovery messages such as EB in IEEE 802.15.4.

When transmitting messages such as network discovery, or solicit, messages, nodes listening to such messages will reset their timers to a low (e.g. minimum interval) value and will begin transmitting messages. Even in cases where there is only a small number of nodes attempting to join a network, still all of the devices (nodes) will reset their timers to the low value and begin transmitting messages. Often, such messages are broadcast asynchronized, and nodes may take a relatively long time to reach the maximum interval time, resulting in a large number of transmissions. In another example, when there is a large number of nodes (e.g. in a personal area network, PAN), the algorithm can lead to a large increase in the number of transmissions.

Therefore, according to the present disclosure, in some applications it may be desirable to reset the Trickle timer (e.g. to the minimum interval duration) upon receipt of the first transmission (which may comprise, e.g., a network discovery message, a solicit message, etc.), for only a few intervals, and then to subsequently and instantly set the interval duration back to a longer interval duration (e.g. the maximum interval duration).

In some examples, a node may decide to stay on a shorter interval duration based on the number of unique transmissions (e.g. unique network discovery messages, or “second transmissions” as described herein) that it receives. For example, the more unique transmissions received by a node, the more intervals the node spends having the shorter interval duration, to enable information to be transmitted more quickly.

In some examples, a node may adjust the redundancy constant (e.g. k) based on the number of nodes in its vicinity. For example, the value of the redundancy constant may be determined based on a density of the network (e.g. a larger value for a sparse network and a smaller value for a dense network). This may be particularly advantageous in increasing redundancy to ensure that a large number of nodes will receive the data packet. In some examples, the redundancy constant may be different for different areas of network, for example a network may comprise dense areas and sparse areas. The redundancy constant may therefore, in some examples, be determined based on a number or density of other nodes in at least part of the network.

In some examples, the redundancy constant may comprise a range of values between a minimum redundancy constant value (kmin) and a maximum redundancy constant value (kmax). If the counter value (e.g. counter, c) lies within the range of values between kmin and kmax, the node may transmit the data packet at a time within an interval having a duration that may be calculated according to e.g. the (local) network density as described herein. If the counter value lies below kmin, then the data packet must be transmitted. In some examples, kmin and kmax may vary with the interval length.

In some examples, a node may decide whether to suppress transmission of a message, or data packet, based on a location (e.g. a global positioning system, GPS location) of other nodes from which transmissions are received. For example, for a node at the center of a circle having quadrants Q1, Q2, Q3, and Q4, if the node receives messages from nodes in Q1 and Q4 only but not from Q2, there is a possibility that nodes in Q2 and Q3 may not have received the message, and so the node at the center should not suppress its own message (data packet). In other words, examples according to the present disclosure may mitigate against the “hidden node problem”.

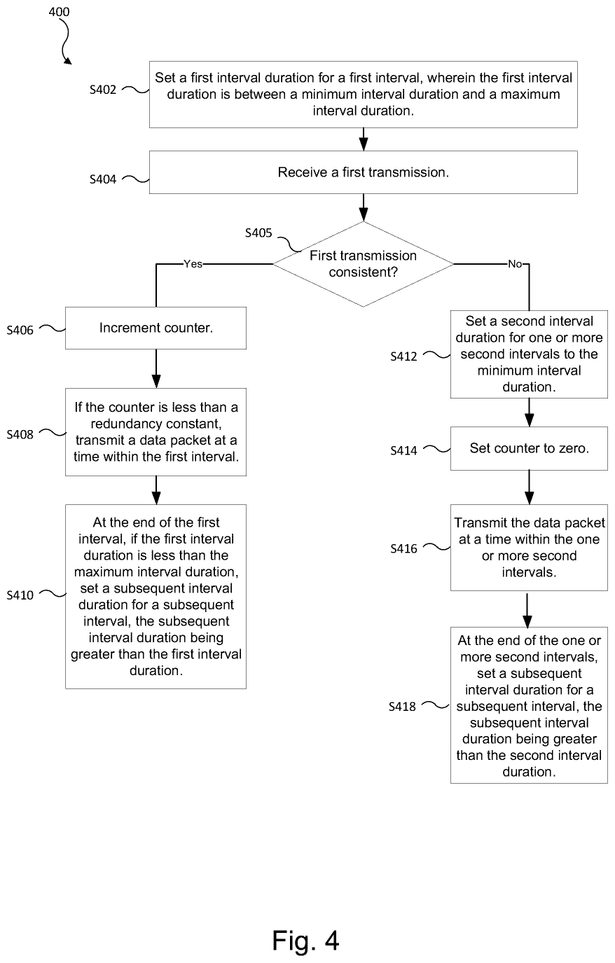

An example of a method 400 for transmitting a data packet in a network (e.g. between nodes in the network, such as a mesh network) according to the present disclosure, in which the interval duration is reset for only one or more intervals, is illustrated schematically in FIG. 4.

In a step S402 of the method 400, a first interval duration for a first interval (e.g. I) is set, wherein the first interval duration is between a minimum interval duration (e.g. Imin) and a maximum interval duration (e.g. Imax).

In a step S404, the method 400 comprises receiving a first transmission (e.g. from another node in the network).

If (at S405) the first transmission is consistent, the method 400 comprises, in a step S406, incrementing a counter (e.g. counter c). If the counter is less than a redundancy constant (e.g. redundancy constant k), the method 400 comprises, in a step S408, transmitting a data packet at a time (e.g. time t) within the first interval. For example, the time within the first interval may occur after half of the first interval duration (i.e. in the range [I/2, I]). If, at the end of the first interval, the first interval duration is less than the maximum interval duration, the method 400 comprises, in a step S410, setting a subsequent interval duration for a subsequent interval, the subsequent interval duration being greater than the first interval duration. For example, the subsequent interval duration may be double the first interval duration. In some examples, the subsequent interval duration may be the maximum interval duration.

If (at S405) the first transmission is inconsistent, the method 400 comprises, in a step S412, setting a second interval duration for one or more second intervals to the minimum interval duration and, in a step S414, setting the counter to zero. In a step S416, the method 400 comprises transmitting the data packet at a time (e.g. time t) within the one or more second intervals. For example, the time within the one or more second intervals may occur (within one or more of the one or more second intervals) after half of the second interval duration (i.e. in the range [I/2, I]). At the end of the one or more second intervals, the method 400 comprises, in a step S418, setting a subsequent interval duration for a subsequent interval, the subsequent interval duration being greater than the second interval duration. For example, the subsequent interval duration may be double the second interval duration. In some examples, the subsequent interval duration may be the maximum interval duration.

Ensuring that Transmission of the Data Packet is not Suppressed Every Time

The Trickle algorithm defined in RFC 6206 suppresses transmission (e.g. by a node) of a data packet if it has received a desired count of consistent transmissions (messages).

In some cases, despite the received information being consistent, it may be required that the node transmits it data packet, for example as described herein with respect to the “hidden node problem”. There can also be conditions where consistent information is unchanged but there is other important information to be transmitted in a network which can change frequently and where resetting trickle is not feasible. For example: information on the size of the network is critical for nodes and can change frequently, but the node needs to ensure that such information is getting transmitted in network on timely manner and is not impacted due to suppression of the message/data packet.

Therefore, according to some examples according to the present disclosure, at least some data packets may be transmitted regardless of the value of the counter (i.e. not suppressed). For example, the data packet(s) may be transmitted if a suppression interval count is greater than or equal to a suppression interval value. In some examples, the number of intervals for which the suppression is prevented, or ignored, may be defined by an ignore interval value.

Preventing suppression of a transmission may be particularly useful in combination with the variable parameters depending on the environment condition, described herein.

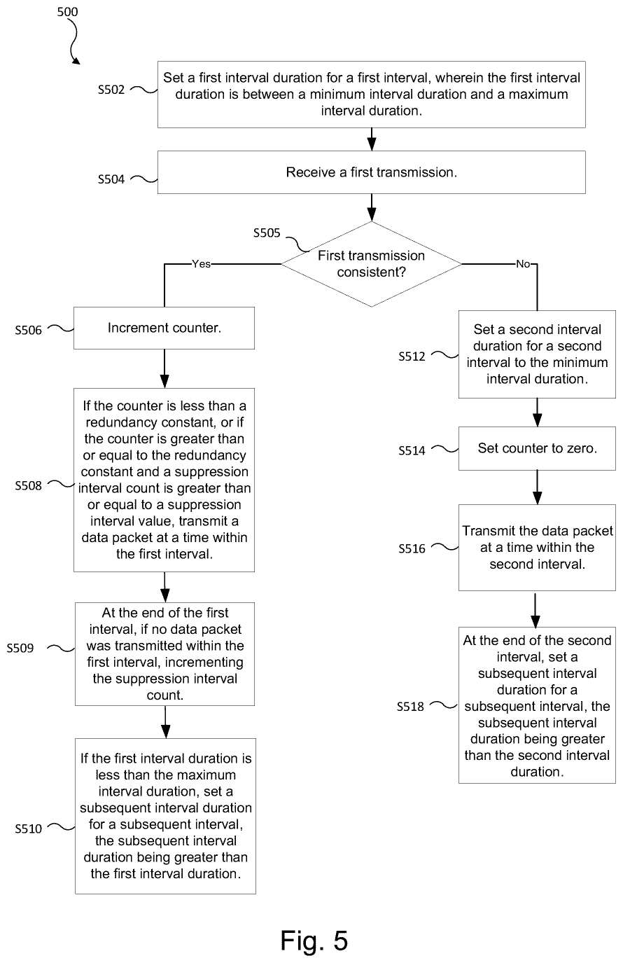

An example of a method 500 for transmitting a data packet in a network (e.g. between nodes in the network, such as a mesh network) according to the present disclosure, in which transmission suppression may be prevented for one or more intervals, is illustrated schematically in FIG. 5.

In a step S502 of the method 500, a first interval duration for a first interval (e.g. 1) is set, wherein the first interval duration is between a minimum interval duration (e.g. Imin) and a maximum interval duration (e.g. Imax).

In a step S504, the method 500 comprises receiving a first transmission (e.g. from another node in the network).

If (at S505) the first transmission is consistent, the method 500 comprises, in a step S506, incrementing a counter (e.g. counter c). If the counter is less than a redundancy constant (e.g. redundancy constant k), or if the counter is greater than or equal to the redundancy constant and a suppression interval count is greater than or equal to a suppression interval value, the method 500 comprises, in a step S508, transmitting a data packet at a time (e.g. time t) within the first interval. For example, the time within the first interval may occur after half of the first interval duration (i.e. in the range [I/2, I]). If, at the end of the first interval, no data packet was transmitted within the first interval, the method comprises, in a step S509, incrementing the suppression interval count. If the first interval duration is less than the maximum interval duration, the method 500 comprises, in a step S510, setting a subsequent interval duration for a subsequent interval, the subsequent interval duration being greater than the first interval duration. For example, the subsequent interval duration may be double the first interval duration.

If (at S505) the first transmission is inconsistent, the method 500 comprises, in a step S512, setting a second interval duration for a second interval to the minimum interval duration and, in a step S514, setting the counter to zero. In a step S516, the method 500 comprises transmitting the data packet at a time (e.g. time t) within the second interval. For example, the time within the second interval may occur after half of the second interval duration (i.e. in the range [I/2, I]). At the end of the second interval, the method 500 comprises, in a step S518, setting a subsequent interval duration for a subsequent interval, the subsequent interval duration being greater than the second interval duration. For example, the subsequent interval duration may be double the second interval duration.

In some examples (not illustrated), when the first transmission is consistent, if an ignore interval count is greater than or equal to an ignore interval value, the suppression interval count may be set to zero.

### General Considerations

It will be understood that each of the examples described and illustrated herein may be combined with any other of the examples described and illustrated herein, as appropriate.

It will be further understood that the descriptions and illustrations of methods described herein are for illustrative purposes only, and that the steps of the methods may be performed in any suitable order.

One or more of the methods and processes described herein may be carried out as an algorithm or computer program. Generally, any of the functions described herein can be implemented using software, firmware, hardware (e.g., fixed logic circuitry), or a combination of these implementations. The apparatuses and methods described herein may be implemented generally by software, firmware, hardware, or a combination thereof. In the case of a software implementation, the method represents program code that performs specified tasks when executed by a processing system (e.g. CPU or CPUs), such as the processing system described herein. The program code can be stored in one or more computer readable memory devices. The features of the techniques described herein are platform-independent, meaning that the techniques may be implemented on a variety of commercial computing platforms having a variety of processors.

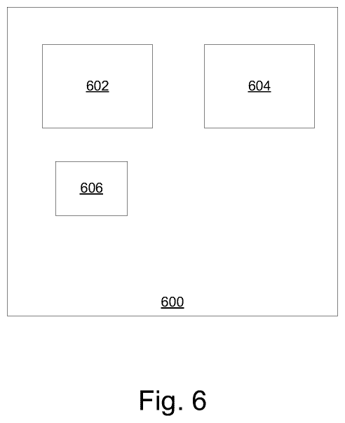

FIG. 6 schematically illustrates an example of a node 600 according to the present disclosure. The node 600 comprises a memory 602 configured to store computer-readable instructions (e.g. software). The node 600 further comprises a processor 604. As described herein, the processor 604 may be provided with the computer-readable instructions stored in the memory 602 which, when executed by the processor 604, cause the processor 604 to carry out one or more of the methods described herein. The instructions may be stored on a non-transitory computer readable medium. A non-transitory computer readable medium can include any electronic, optical, magnetic, or other storage devices capable of providing a processor with computer readable instructions or other program code. Non-limiting examples of a computer readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

In general, the node 600 may be connected or connectable to a network (e.g. a mesh network), such as the internet, a local area network, or a PAN. The node 600 may comprise a communication device 606 such as an antenna and/or a radio to enable the node 600 to connect to the network. The communication device 606 can include any device or group of devices suitable for establishing a wired or wireless data connection to one or more data networks, e.g. a transceiver device, such as a radio frequency (RF) transceiver, capable of transmitting and receiving RF communication from other nodes in the network (e.g. mesh network). The communication device 606 may comprise a network interface device. Non-limiting examples of a network interface device include an Ethernet network adapter, a modem, and/or the like. The processor 602 is able to communicate with processors of other nodes via the network (e.g. the internet, and/or a local area network, and/or PAN) using the communication device 606. Communications with the processors of other nodes may comprise transmissions as described herein (e.g. the first and/or the second transmission) as well as the transmission of data packets. For example, the node 600 may receive transmissions (e.g. the first and/or second transmission) via the communication device 606. For example, the node 600 may transmit one or more data packets to other nodes in the network via the communication device 606.

The node 600, along with any other nodes in the network (e.g. the second node described herein) may comprise smart devices (e.g., resource consumption meters, vehicles, home appliances, etc. that include communication technology).

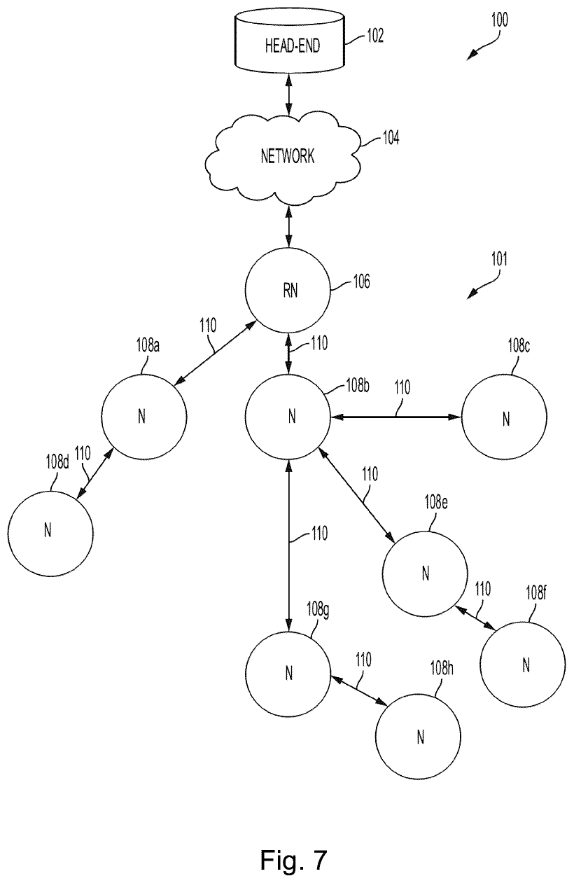

FIG. 7 is a block diagram illustrating an example of a networked system 100 and a mesh network 101. The networked system 100 and the mesh network 101 provides a network infrastructure for smart devices (e.g., resource consumption meters, vehicles, home appliances, etc. that include communication technology) to communicate across a network of nodes (i.e., other smart devices), the internet, and/or an intranet. The networked system 100 includes a head-end system 102, which may function as a central processing system that receives a stream of data from a network 104. The network 104 may be the internet, an intranet, or any other data communication network. The mesh network 101 may include a root node 106 and other nodes 108a-108h collecting data associated with the nodes 106 and 108a-108h, and the root node 106 transmits the collected data to the network 104 and ultimately to the head-end 102 of the networked system 100. In addition, the root node 106 may also receive from the head-end 102 network management messages and transmit the network management messages to the nodes 108a-108h. Likewise, the root node 106 itself or other nodes 108a-108h may also issue and transmit network management messages to other nodes 108a-108h. The data and network management transmitted between the nodes 106, 108a-108h may be collectively referred to herein as “transmissions” (e.g. “first transmission”, “second transmission”, etc.), “communications” and/or “data packets”. These transmissions (and/or communications, and/or data packets) are transmitted and routed through data links 110 between the nodes 106, 108a-108h. The root node 106 may be a personal area network (PAN) coordinator, an internet gateway, or any other device capable of connecting to the network 104.

The root node 106 may generally be referred to as a parent node due to data links with the nodes 108a and 108b that are located at a node layer (e.g., layer one) below the root node 106. For example, the root node 106 is illustrated as communicating directly with the network 104. As illustrated, nodes 108a and 108b may also be referred to as parent nodes due to data links with nodes 108c, 108d, 108e, and 108g that are located at a node layer (e.g., layer two) below the nodes 108a and 108b. Further, nodes 108e and 108g may be referred to as parent nodes due to data links with nodes 108f and 108h that are located at a node layer (e.g., layer three) below the nodes 108e and 108g. The nodes 108a-108h may all funnel information up through the node layers to the root node 106 and ultimately to the head-end 102.

Each of the nodes 106 and 108a-108h are linked with at least one of the other nodes 106 and 108a-108h. Links 110 may be created by storing neighboring node information in neighbor caches of the nodes 106 and 108a-108h that provide indications to the nodes 106 and 108a-108h of the other nodes 106 and 108a-108h through which data may be routed. For example, the neighbor cache of the node 108h may include neighboring node information identifying that data collected at the node 108h should be transmitted to the node 108g. Likewise, the neighbor cache of the node 108g may include neighboring node information identifying that the node 108g should transmit relevant information to the node 108h (e.g., network management messages or other information from the head-end 102) and also identifying that the node 108g should transmit data collected by the node 108g and data received from the node 108h to the node 108b. Such a data transmission scheme may continue up through the node layers of the mesh network 101.

In operation, fewer or more nodes 108 may be included in the mesh network 101, and more root nodes 106 may also be included in the networked system 100. Additionally, while the mesh network 101 depicted in FIG. 7 includes a root node layer (i.e., the root node 106), layer one (i.e., the nodes 108a and 108b), layer two (i.e., the nodes 108c, 108d, 108e, and 108g), and layer three (i.e., the nodes 108f and 108h), fewer or more node layers are also contemplated. Moreover, while FIG. 7 depicts a specific network topology (e.g., a DODAG tree topology), other network topologies are also possible (e.g., a ring topology, a mesh topology, a star topology, etc.).

It will be understood that any of the nodes 106, 108a-108h of the mesh network 101 may comprise a node 600 of the kind illustrated in FIG. 6 and described herein.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

1. A method for transmitting a data packet, the method comprising:
setting a first interval duration for a first interval, wherein the first interval duration is between a minimum interval duration and a maximum interval duration;
receiving a first transmission;
if the first transmission is consistent:
incrementing a counter;
if the counter is less than a redundancy constant, transmitting a data packet at a time within the first interval;
if the counter is greater than or equal to the redundancy constant, and if a suppression interval count is greater than or equal to a suppression interval value, transmitting the data packet at the time within the first interval; and
at the end of the first interval:
if no data packet was transmitted within the first interval, incrementing the suppression interval count;
if the first interval duration is less than the maximum interval duration: setting a subsequent interval duration for a subsequent interval, the subsequent interval duration being greater than the first interval duration;
if the first transmission is inconsistent:
setting a second interval duration for a second interval to the minimum interval duration;
setting the counter to zero;
transmitting the data packet at a time within the second interval; and
at the end of the second interval, setting the subsequent interval duration for the subsequent interval, the subsequent interval duration being greater than the second interval duration.

2. A method according to claim 1, comprising, when the first transmission is consistent:
if an ignore interval count is greater than or equal to an ignore interval value, setting the suppression interval count to zero.

3. A node in a mesh network, the node comprising:
a processor; and
a memory configured to store computer-readable instructions that, when executed by the processor, cause the processor to perform operations comprising:
setting a first interval duration for a first interval, wherein the first interval duration is between a minimum interval duration and a maximum interval duration;
upon receipt by the node of a first transmission:
if the first transmission is consistent:
incrementing a counter;
if the counter is less than a redundancy constant, causing the node to transmit, at a time within the first interval, a data packet to a second node of the mesh network;
if the counter is greater than or equal to the redundancy constant, and if a suppression interval count is greater than or equal to a suppression interval value, transmitting the data packet at the time within the first interval; and
at the end of the first interval:
if no data packet was transmitted within the first interval, incrementing the suppression interval count;
if the first interval duration is less than the maximum interval duration: setting a subsequent interval duration for a subsequent interval, the subsequent interval duration being greater than the first interval duration;
if the first transmission is inconsistent:
setting a second interval duration for a second interval to the minimum interval duration;
setting the counter to zero;
transmitting the data packet at a time within the second interval; and
at the end of the second interval, setting the subsequent interval duration for the subsequent interval, the subsequent interval duration being greater than the second interval duration.

4. A node according to claim 3, wherein the operations further comprise, when the first transmission is consistent:
if an ignore interval count is greater than or equal to an ignore interval value, setting the suppression interval count to zero.
